(19) United States
(12) Patent Application Publication
(10) Pub. No.: US 2008/0209464 A1
(43) Pub. Date: Aug. 28, 2008

(54) Mobile Cable Subscription

(75) Inventor: Patrick Wright-Riley, Villanova, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/678,202

(22) Filed: Feb. 23, 2007

(51) Int. Cl. H04N 7/16

(52) U.S. Cl. 725/25

(57) ABSTRACT

A system, method and computer readable medium are described that allow a traveler to receive content similar to what that subscriber receives at home. In one case, the subscriber receives local content but at a tier of service that is similar to the tier of service the subscriber enjoys at home. In another case, the head-end in the home region forwards some or all content to the head-end in the remote region for distribution to the subscriber. In yet another case, the subscriber's set-top box located in his home is used to transmit all the content to a set-top box in the remote region. Finally, the subscriber's set-top box located in his home is used to transmit the content, one content service at a time to a set-top box in the remote region.

### FIELD OF THE INVENTION

This invention relates generally to accessing a cable network's service offerings, when the user is traveling, using the offerings they subscribe to on their home cable network.

### BACKGROUND OF THE INVENTION

Cable television is operated by a plurality of multiple system operators (MSO) across the country. Thus, one MSO supplies television, movies and audio programming to one region of the country and another MSO supplies similar, but often not identical, media content to another region. The content services the MSOs offer vary greatly from region to region. Thus when a person travels outside of his region, he will get differing media content being offered by the MSO serving that region.

In addition to the differing media content offerings across regions, many MSOs offered tiered services. That is, a subscriber pays a certain amount for a certain amount of content. For example, a first tier may allow the subscriber to watch 100 channels of television and movie programming; a second tier subscriber in the same region may get 150 channels; and a third tier subscriber may receive 200 channels and some of those channels may be premier channels.

Hotels and motels are aware of the disparity in offering media content across regions and across tiers. In an effort to make their guests more comfortable, a hotel will register for a lot of media content or one of the higher tiers offered by the MSO serving that region. While this generally gives the hotel guest a great number of choices in consuming media content, it also causes the hotel to spend money on a lot of programming. Some of that programming may not be watched by its guests. This cost of course is then passed down to the guests.

On the contrary, some hotels and motels may see offering a large variety of content as being cost prohibitive and thus opt to provide only basic content even though they may have capacity to offer more. Generally these hotels and motels are at a disadvantage when trying to attract higher end guests due at least in part to their limited content offering.

In addition, some hotel guests may want local programming. As an example, an MSO in one region will not carry the local news of another region. Thus, with all of the media content available via the hotel's paid for premier tier service, it will still not be what some hotel guests want to watch.

This problem extends beyond hotels and motels. Similar to hotels and motels are hospitals that offer television services to their patients. Additionally, many people visit family or friends in different regions. When they arrive, the guest must accept the content offered by the MSO serving that region and the tier of programming selected by the homeowner in that region. In some cases, the guest would like to receive content that is the same or similar to the content provided by their tier of service in their home region.

### BRIEF DESCRIPTION OF THE DRAWINGS

FIG. 1 shows two regions being served by two different MSOs for distributing content to subscribers;

FIG. 2 is a block diagram of the head-ends shown in FIG. 1;

FIG. 3A is an illustration of a data table for storing customer account data;

FIG. 3B is an illustration of a data table for storing viewing tier to content correlation data;

FIG. 4 is a flowchart for a method for distributing content in one region based on an account in another region;

FIG. 5 is a flowchart for a method for distributing content in one region that comes from another region;

FIG. 6 a block diagram of another system for distributing content from one region to another;

FIG. 7 is a flowchart for a method for distributing content in one region to another region;

FIG. 8 is another flowchart for a method for distributing content in one region to another region; and

FIG. 9 is a block diagram of a set-top box.

### DETAILED DESCRIPTION OF THE DRAWINGS

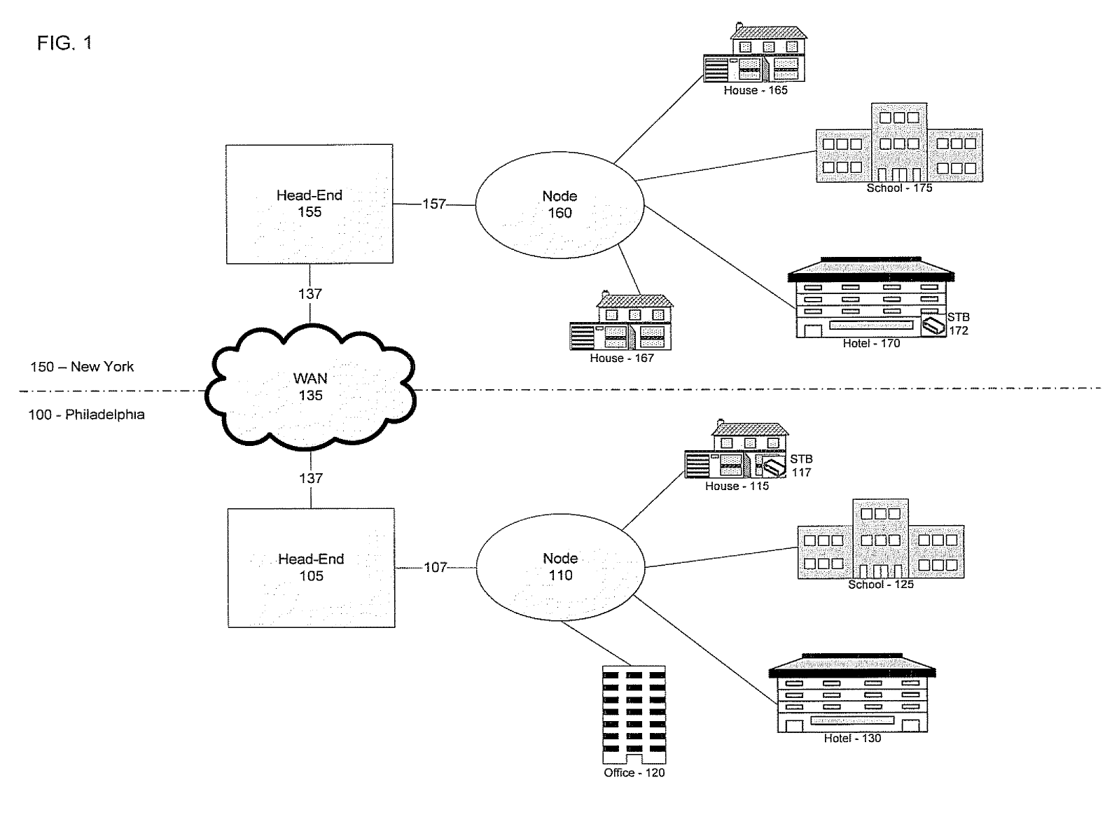

FIG. 1 shows two regions, Philadelphia 100 and New York 150, being served by two different MSOs. Region 100 includes at least one head-end 105 and a plurality of nodes 110 (only one is shown for the sake of clarity). A head-end is a cable system back office that aggregates, encrypts, and distributes content. Examples of content include broadcast television programs, movies distributed on a movie channel and music. A node is a device placed away from the head-end and in a neighborhood that amplifies and distributes the content it receives from the head-end.

A plurality of homes, office buildings, schools and hotels, 115, 120, 125 and 130, respectively, are coupled to node 110. A hybrid fiber coaxial (HFC) network 107 couples head-end 105 to node 110 and home 115, office 120, school 125 and hotel 130. Head-end 105 is also coupled to wide area network (WAN) 135. A single line 137 is shown as a connection between head-end 105 and head-end 155 in FIG. 1. It should be understood that this does not require a dedicated connection between the two. Instead, packet-based messages may be sent between the two through WAN 135 using a plurality of connection points.

Home 115 includes set-top box 117. A set-top box is any device that receives content from a distribution point, such as a node, and processes it so it can be rendered by a television, computer monitor or set of speakers. Set-top box 117 may be a separate stand-alone device or it may be integrated into the television, monitor or speakers. Examples of processes performed by the set-top box include demodulation, decryption, decoding etc.

Region 150 is similarly arranged with head-end 155, HFC network 157, node 160, homes 165 and 167, hotel 170, school 175 and set-top box 172. Head end 155 is also coupled to WAN 135. It should be noted that WAN 135 and HFC networks 107 and 157 could be the same or share parts of each other's networks.

Media content such as television programs, movies and music is received or stored at head-ends 105 and 155. The head-ends 105 and 155 distribute this content to the nodes 110 and 160, respectively. The nodes 110 and 160 in turn distribute the content to the homes, hotels, schools and office buildings. Each head-end 105 and 155, however, may or may not be distributing different content; more to the point, some of the content will be the same, as in nationally carried content, and some will be specific to each region, 100 and 150, as is the case with local content. Thus, the selection of media content a user may choose from in home 115 is different than the media selection in hotel 170.

To compensate for this discrepancy, WAN 135 passes control signals and content between head-ends 105 and 155. That way, the homeowner of home 115 can receive the same or a substantially similar block of, content whether he is in home 115 in region 100 or hotel 170 in region 150.

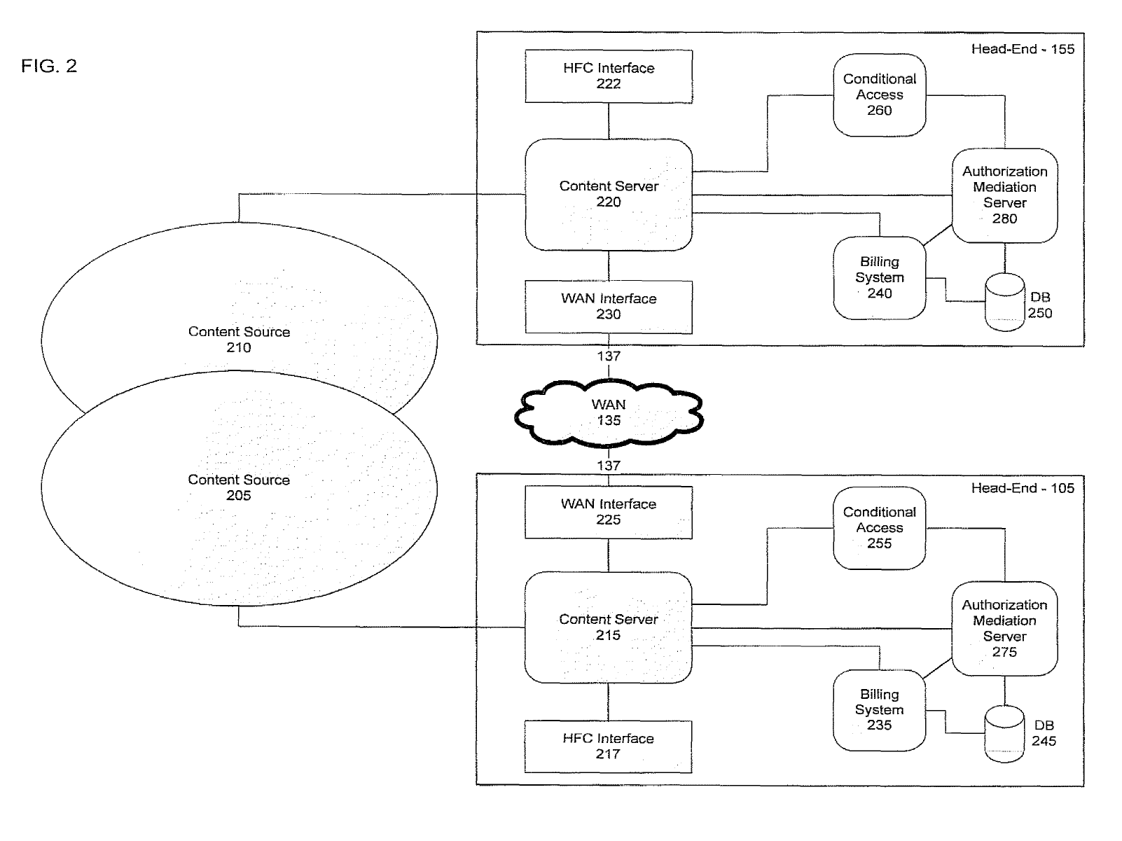

FIG. 2 is a block diagram of the head-ends 105 and 155 shown in FIG. 1. Head-end receives media content from content source 205 and head-end 155 receives content from content source 210. As is known in the art, head-ends receive content from a plurality of discrete sources (i.e., different television stations such as ABC, CBS, NBC and movies for showing on premium channels such as HBO). For the sake of clarity, the plurality of discrete sources are grouped together into content sources 205 and 210 in FIG. 2.

As is also know, the head-ends in different regions have access to both the same and different sources of content. That is, head-end 105 can distribute some of the same content as head-end 155 (such as HBO, The Weather Channel, or other national content services). Thus, content sources 205 and 210 are shown as overlapping such that the same content is available in some regions and not in others. Each head-end has a content server 215 and 220. The content server formats the various pieces of content received from content sources 205 and 210 for distribution. This formatting, in some implementations, includes modulating the content onto specific frequency bands or adding conditional access controls overlaid on the content. The content is then forwarded to HFC interfaces 217 and 222 for distribution to the nodes, homes, offices etc. as previously described.

Head-ends 105 and 155 also include WAN interfaces 225 and 230 for communications over WAN 135, using the connection 137. As will be described later, these communications may encompass content from content sources 205 and 210, access control signals, or a combination of both. It should also be noted that in some implementations, each head-end 105 and 155 may have only one interface such that HFC interfaces 217 and 222 are part of, or are the same as WAN interfaces 225 and 230.

Also coupled to content servers 215 and 220 are billing systems 235 and 240, respectively. Billing systems 235 and 240 maintain records identifying each subscriber and tracking what content each is authorized to receive and pay for on a subscription basis, as well as tracking special event purchases such as pay-per view events or video-on demand (VOD). Billing systems 235 and 240 also track which tier service each customer is buying. Customer records associated with billing are maintained in databases 245 and 250, respectively.

Also coupled to content servers 215 and 220 are conditional access servers 255 and 260. Conditional access servers manage encryption keys that limit and/or control access to specific content and ensure that each subscriber receives the correct keys for the content he or she is entitled to consume. Conditional access servers 255 and 260 are coupled to billing systems 235 and 240, respectively, so that a customer receives the content paid for, be it subscription based or on demand.

Finally, each head-end 105 and 155 includes an authorization mediation server 275 and 280, respectively. The authorization mediation servers 275 and 280 pass viewing tier or viewing content information to each other, from one head-end 105 to another 155 to allow a user in home 115 to view the same or similar content from hotel 170. The authorization mediation servers 275 and 280 are coupled to content servers 215 and 220; billing systems 235 and 240 and conditional access systems 255 and 260, respectively.

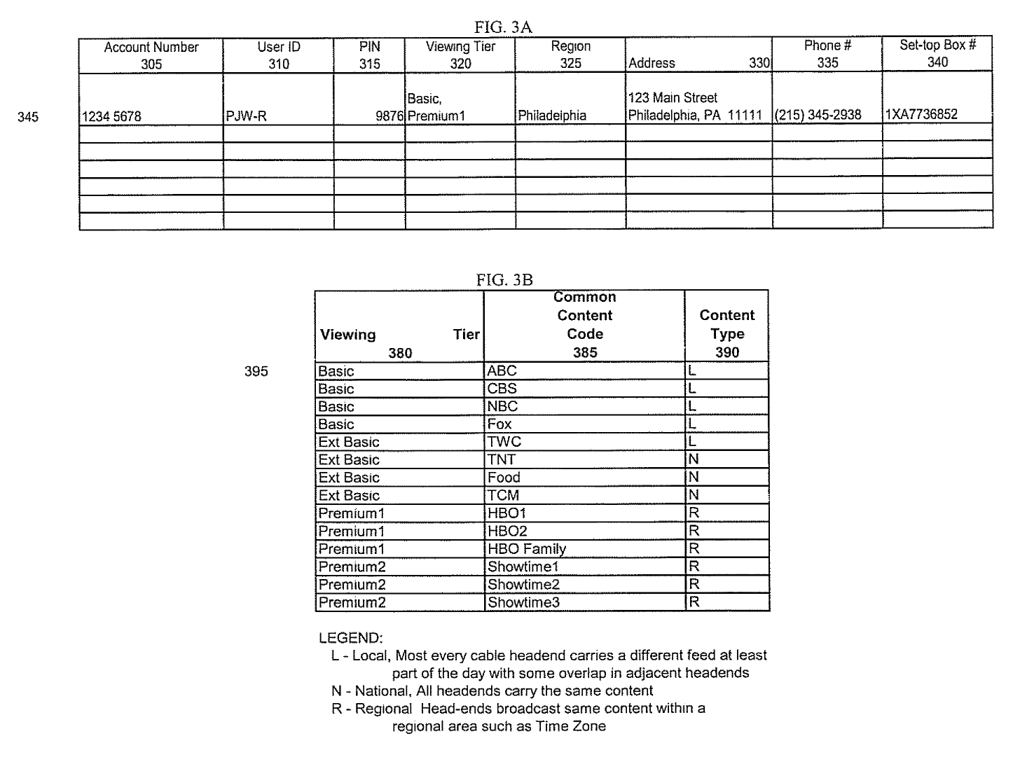

FIG. 3A shows a data table that is representative of some of the data stored in database 245 or 250. A subscriber in one region will have an account number 305. This account number is primarily used for billing and authentication. Since remembering an account number can be difficult, this illustrative data table also includes user ID section 310. The user ID 310, like the account number 305, is unique for each subscriber; however it is easier for the customer to remember the user ID 310 as it can be based on the user's name or other word or phrase that a user is more likely to remember.

In addition, a PIN 315 is also stored. As will be described later, PIN 315 is used to gain remote access to content presented in another region. A viewing tier 320 holds viewing tier data. This is a rough indication of what channels and services the subscriber has paid for. As stated previously, subscribers will pay for different tiers of service to receive different amounts of content.

Region 325 stores a region or nearby major city. This data is used to help locate the head-end that services the subscriber's home. Address 330 holds the subscriber's residential address and phone number 335 holds the subscriber's phone number associated with this account. Finally, set-top ID number 340 is the unique number from one or more set-top boxes associated with that account. An entire row across this data table is an account record 345.

FIG. 3B shows an additional data table that is representative of some of the data stored in database 245 or 250. In order for the authorization mediation servers 275 and 280 to determine what content a given subscriber has in their viewing tier 320, or to correlate such data from another region, there may be a common set of content codes that uniquely identify content, be it subscription, pay-per-view, VOD, or other such content. This allows the authorization mediation servers 275 and 280 to correlate the content for and from other regions. An example of similar definitions relates to how program guide providers currently identify services across regions in order to provide the appropriate guide information for that service. The ABC network affiliate in the Philadelphia region 100 may be different from the ABC network affiliate in the New York region 150, thus the guide provider must know this difference and provide the proper guide data to each. Likewise, the authorization mediation servers 275 and 280 must be able to correlate content to determine when they are the same or different.

Thus the viewing tier 380 can be unique to each head-end 100 and 150 and correlates to the entry or entries contained in the viewing tier 320. This field will be repeated for each content service contained in that viewing tier. The common content code 385 contains a common content service identifier or code that every authorization mediation server uses to identify specific content for a specific locale. The content type 390 may also be common across every authorization mediation server and is used to denote whether content is carried nationally, as in TBS or TNT, is carried regionally, as in HBO which has an Eastern feed serving east and central time zones and a Western feed serving mountain and west time zones, or locally as in the four broadcast networks or The Weather Channel which are specific to local viewing areas. An entire row across this data table is a content record 395 for a single media content service.

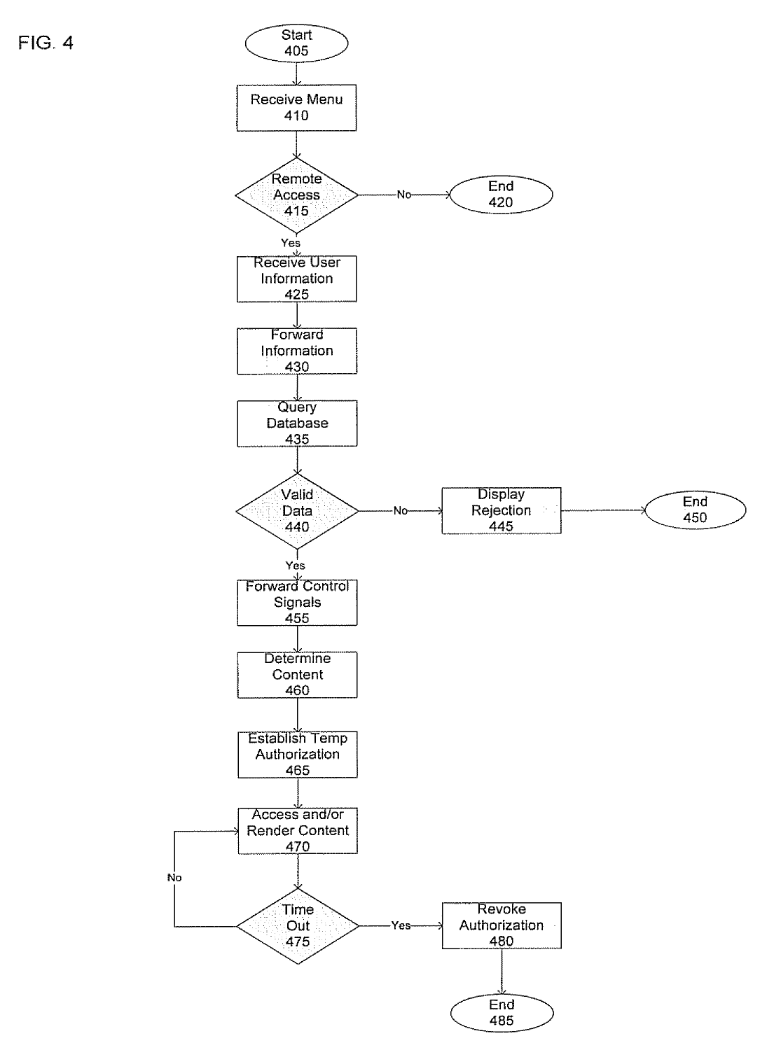

FIG. 4 is a flowchart of a process for obtaining remote access to content in another region. In describing this process, assume the subscriber is a resident in home 115 in the Philadelphia region 100 and is staying at hotel 170 in the New York region 150. Of course in other scenarios the subscriber could be staying with a friend in home 165 or 167. The process begins at step 405. At step 410, set-top box 172 in hotel 170 offers a menu of options. The menu may be automatically presented such as when set-top box 172 is turned-on or if the subscriber requests it by pressing a button on a remote control. The menu includes options for receiving content from this region (i.e., from head-end 155 based on the tier of service ordered for set-top box 172), ordering video-on demand, ordering music, playing video games and requesting content from another region, among other possibilities.

At step 415, set-top box 172 determines what inputs the user entered. If in response to that menu the user selects anything but content from another region, the process ends at step 420. If at step 415 the user selects content from another region, the process continues at step 425 where set-top box prompts the user to enter certain information. In one illustrative example, the user is prompted to enter 1) the region or major city nearest the user's home, 2) a user ID or telephone number, 3) a PIN and 4) the length of time to receive the content or a departure date and time.

At step 430 the user input information is transmitted from set-top box 172 to head-end 155. In this transmission step, set-top box 172 bundles the user input data with instructions. In one implementation, these instructions request head-end 155 to supply programming to set-top box 172 beyond or in lieu of the programming provided to set-top box 172 based on the tier service for which it is subscribed. As an example, if the guest has a premium tier of service in his home region and is visiting a friend in another region who only has a basic tier of service, the instructions will request that head-end 155 supply its premium tier of service to set-top box 172. It should be understood that these instructions may be needed by both head-end 155 and head-end 105 to provide set-top box 172 with the desired content.

At step 430, authorization mediation server 280 forwards the user input data with a request for authorization from another head-end (i.e., head-end 105). These instructions and data can either be broadcast to all the other head-ends coupled to WAN 135 or the authorization mediation server 280 may analyze the user input data and select one or a few head-ends (e.g., unicast or multicast) to transmit this message to. Authorization mediation server 280 can make this determination based on the user entering a region or nearby major city in step 425. The message is then transmitted at step 430.

At step 435, the authorization mediation server 275 in head-end 105 receives the message, decodes it, and requests the billing system 235 to look-up the corresponding data. That is, if the user entered a user ID or telephone number, authorization mediation server 275 forwards that data to billing system 235. Billing system 235 queries database 245 and returns record 345 of FIG. 3A to authorization mediation server 275.

At step 440 authorization mediation server 275 compares the PIN number entered by the user with the PIN retrieved from data base 245 via billing system 235. If there is no match, then a presumption is made that the person attempting access is not authorized. Authorization mediation server 275 sends a message to authorization mediation server 280. In another implementation, subscriber information is not found in database 245 by billing system 235 and a response to that effect is returned. In either case, authorization mediation server 280 then displays a message informing the user that remote access of content has been denied at step 445. The process then ends at step 450.

If at step 440, user entered data matches the data retrieved from database 245, authorization mediation server 275 will then correlate the viewing tier(s) 320 to the viewing tier(s) 380 of the appropriate content records 395 of FIG. 3B to retrieve the common content codes 385 and their corresponding content types 390 and forward this control information to authorization mediation server 280 at step 455. In this illustrative method this control information includes not only the appropriate common content codes and corresponding content types but instructions for authorization mediation server 280 to distribute a particular set of content to set top box 172 as well. In another implementation the authorization mediation server 275 may not correlate the viewing tiers 320 to the viewing tiers 380 and forward only the viewing tiers 320 retrieved from database 245 to authorization mediation server 280 at step 455.

At step 460 authorization mediation server 280 determines the content to send to set-top box 172. In one illustrative method, authorization mediation server 280 compares the common content codes 385 for this account received from authorization mediation server 275 and the content services offered by the MSO in region 150. Authorization mediation server 280 will attempt to match the content as close as possible, adjusting for various content types. In another implementation, authorization mediation server 280 compares the common content codes received from authorization mediation server 275 to those in its content records table and selects a viewing tier or group of viewing tiers offered in region 150 that most closely match the programs received by the user in home 115 of region 100. In another implementation, authorization mediation server 280 may attempt to correlate the viewing tiers 320 received from authorization mediation server 275 to its own viewing tiers 320 and make a best effort to authorize the same level of content, without differentiating to the common content level.

Depending on the instructions carried in the control information, the authorization mediation server 280 may treat local or regional services as different and unique and not carry the authorization(s) across. As an example, the user from home 115 who is authorized for the ABC network for the Philadelphia region 100 may not be granted access to the ABC network in the New York region 150, staying in hotel 170 because the ABC networks are seen as different and distinct based on their combination of locally originated and nationally carried content. In another implementation the authorization mediation server 280 may ignore the content type and simply treat all services as common based solely on the common content code. In this same example, the user from home 115 would be granted access to the ABC network for the New York region 150, based on his or her authorization for the ABC network in the Philadelphia region, 100.

At step 465 authorization mediation server 280 instructs conditional access server 260 to send the appropriate encryption keys to set-top box 172 so it can render the programs selected by authorization mediation server 280 in step 460. Once set-top box 172 is initialized with all appropriate encryption keys, set-top box 172 begins accessing and/or rendering content in step 470. It should be understood that set-top box 172 will already contain, and receives periodic updates of the channel map for all of the content being distributed to it by head-end 155.

At step 475, authorization mediation server 280 checks the time and date based on the user input in step 425. If the time limit hasn't expired, as determined in step 475, the process continues to access and/or render content at step 470. If the time period has expired, authorization mediation server 280 sends instructions to conditional access server 260 at step 480 to change the encryption keys it is using for set-top box 172. Conditional access server 260 will reauthorize set-top box 172 for its original content and set-top box 172 will be unable to render the content previously authorized that was unique to the viewer in home 115. Instead, set-top box 172 will revert back to receiving and providing the content to the user as established by the original service tier for it. The process then ends at step 485.

As previously described, process 400 exchanges control signals between head-ends 105 and 155. Thus, the user in hotel 170 receives content from content source 210 that most closely matches the content he receives at home 115. Because of the overlap in content sources 205 and 210, a user may get many of the programs he would normally consume at home. However, some other programs, such as local programs that are only broadcast in region 100 would still not be provided to the user in hotel 170. This implementation, however, does not require more bandwidth in region 150. That is, the universe of content, as identified by content source 210, doesn't change, just one more set-top box 172 has access to a different sub-set of that content that aligns closely with the content provided to set-top box 117.

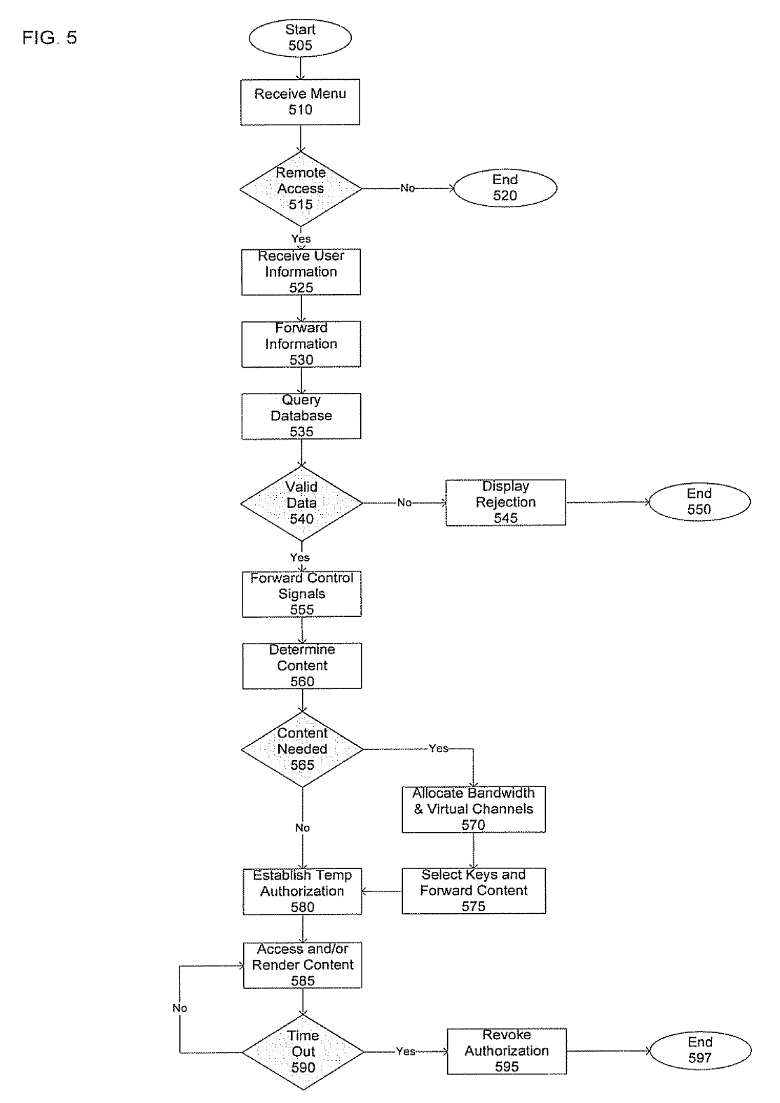

FIG. 5 shows an alternative implementation of a method for providing content to a subscriber in a remote region. Steps 505-560 are the same as steps 405-460 in FIG. 4. The reader is referred to the description above of steps 405-460 for a description of steps 505-560, respectively.

At step 565, authorization mediation server 280 determines if any services authorized for user at home 115 are not offered to the hotel 170 and generates of list of needed content.

If the list generated in step 565 is empty (i.e., content server 220 is already distributing all of the same content in the user's home region), the process proceeds to step 580. This may also occur when the user stays within his home region but goes to a friend's house who has subscribed to a different set of services such as “basic” compared to the user's “premium” services subscribed to at his home.

If the list generated in step 565 is not empty, it is sent to authorization mediation server 275 with instructions requesting content from the user's home head-end 105. Unlike process 400 shown in FIG. 4, process 500 will have head-end 105 distribute content to head-end 155 for further distribution to set-top box 172. These instructions and data can either be broadcast, multicast, or unicast as previously described.

At step 570, authorization mediation server 280 instructs content server 280 to allocate bandwidth for addition media content. That is, content server 220 has some bandwidth on reserve that it can use for this purpose. Authorization mediation server 280 estimates how much bandwidth that may be needed to forward to set-top box 172 the user's desired content.

In an alternative implementation, the authorization mediation server 280 instructs conditional access server 260 to allocate virtual channels on which the new content will be viewed by set-top 172. In some applications, a virtual channel is not defined by a specific carrier frequency, but rather by certain identifying data inserted into a stream of content. Thus, for example, one piece of content is identified and processed using identifier 1234 and another piece of content is identified using identifier 5678. Once the channels are determined by conditional access server 260, an updated channel map is then sent to set-top box 172 so it can process the content on those channels by establishing a secure link with set-top 172 and adding the temporary channels to the channel line-up or channel map of set-top 172.

The content normally distributed to set-top box 115 from head-end 105 (e.g., from content source 205) is then forwarded from content server 215 over WAN 135 to content server 220 in step 575. Before this content is sent over WAN 135, encryption key(s) must be allocated for the temporary content. Authorization mediation server 280 instructs conditional access server 260 to assign unique encryption keys to the content being temporarily passed from content server 215 on head-end 105 to content server 220 in head-end 155. Content server 220 then modulates and encrypts that content onto the channels allocated in step 570 and forwards that content to HFC interface 222 for distribution to set-top box 172.

At step 580 authorization mediation server 280 instructs conditional access server 260 to send the necessary encryption keys to set-top box 172 as was done in step 465. In one implementation, conditional access server 260 supplies set-top box 172 with two sets of temporary keys. Thus, if content is being forwarded from content source 205 to content server 220 via content server 215, i.e. the list of missing content is not blank, the authorization mediation server 280 instructs conditional access server 260 to authorize set-top 172 with the first set encryption keys for the temporary content coming from content server 215 via WAN 135. In addition, if head-end 155 can distribute some of the desired content itself as it normally does, the second set of encryption keys will be for the new temporary services coming from head-end 155. Thus, conditional server 260 authorizes the hotel set-top 172 with all the appropriate encryption keys.

At step 585, the set-top box, in conjunction with a television, monitor or stereo, renders the content. Steps 590, 595 and 597 check for a time-out condition as was described in steps 475, 480 and 485 above, returning to step 585 if the timeout has not yet occurred. Additionally, if content is being forwarded from content source 205 to content server 220 via content server 215, i.e. the list of missing content is not blank, upon timeout, the conditional access server 260 recovers the encryption keys for the temporary services, content server 215 ceases passing content to content server 220, and content server 220 recovers the bandwidth allocations.

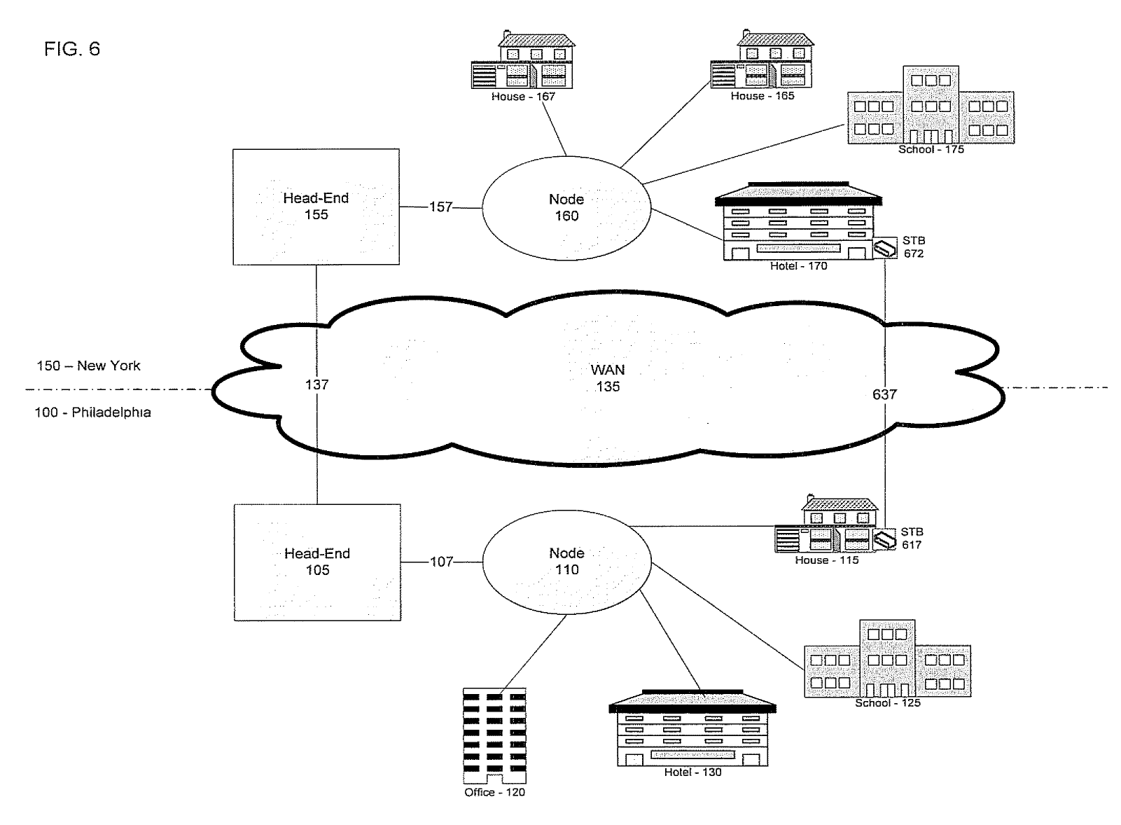

A different system is shown in FIG. 6. Many of the elements in FIG. 6 are identical to the elements shown in FIG. 1 and share like reference numbers. One distinction is set-top boxes 617 and 672 are built and/or programmed to exchange data directly between the two (e.g., does not necessarily go through head-ends 105 and 155). Thus, content is sent from head-end 105 to set-top box 617 which forwards the content to set-top box 672 over link 637 and head-end 155 is not used in transmitting content.

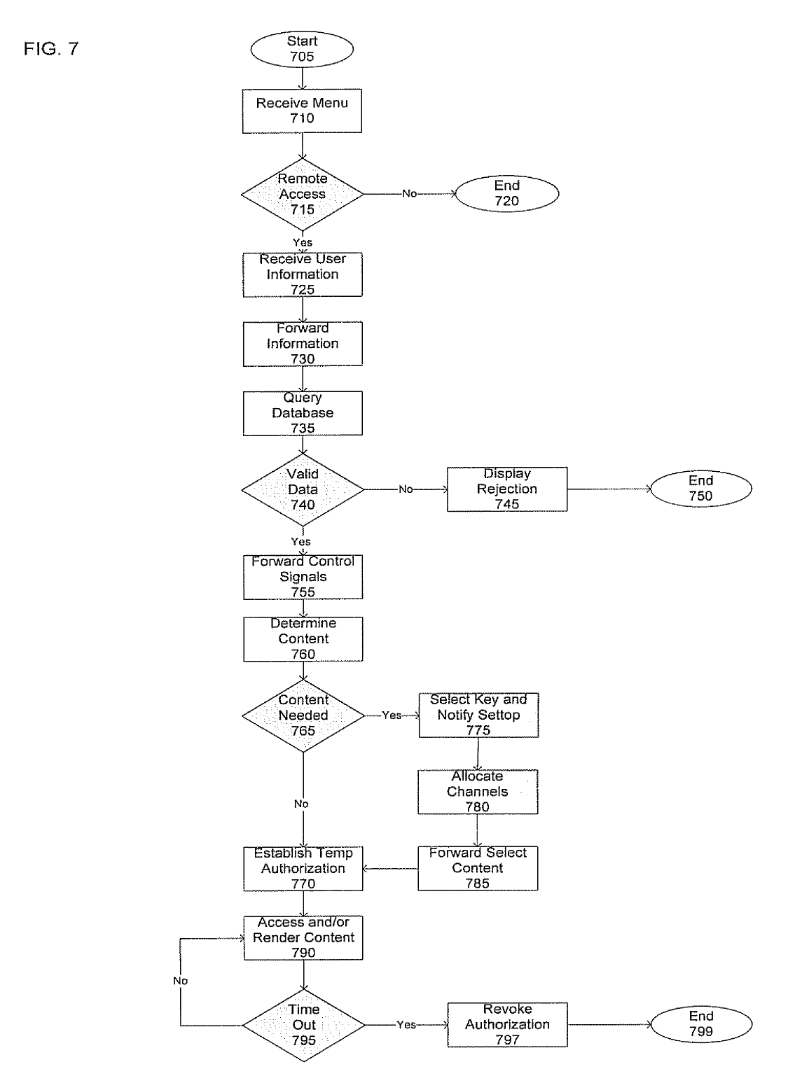

FIG. 7 shows a flowchart for a process for transmitting content from one region to another via the set-top. In this implementation, the source or home set-top is not bandwidth constrained and is thus able to deliver all missing content to the requesting or visiting set-top. Steps 705-760 are the same as steps 405-460 in FIG. 4. The reader is referred to the description of FIG. 4 above.

At step 765, authorization mediation server 280 determines if any services authorized for user at home 115 are not offered to the hotel 170 and generates of list of needed content.

If the list generated in step 765 is empty, the process proceeds to step 770. See the description of step 565 above.

If the list generated in step 765 is not empty, then in step 775 the authorization mediation server 280 sends the list of services to be sent by set-top 617 to authorization mediation server 275 with instructions requesting content from the user's home set-top 617 be sent to set-top 672 at hotel 170. Additionally, authorization mediation server 280 sends a list of available encryption keys retrieved from conditional access server 260 to authorization mediation server 275. Authorization mediation server 275 compares the list of available encryption keys received from authorization mediation server 280 with the available list retrieved from conditional access server 255 and identifies an available key to be used by set-top 617. Because the content is being sent from set-top 617 directly to set-top 672, all the content can be encrypted with a single key. Authorization mediation server 275 then passes the encryption key back to conditional access server 255 to reserve it and to authorization mediation server 280, which passes it back to conditional access server 260 for use in its temporary authorization process at step 770. Finally, authorization mediation server 275 notifies set-top 617 to prepare to send all or some services to set-top 672.

At step 780, authorization mediation server 280 instructs conditional access server 260 to allocate virtual channels on which the new content will be viewed by set-top 172. Conditional access server 260 establishes a secure link with set-top 672 and adds the temporary channels to the channel line-up of set-top 672

At step 785, authorization mediation server 275 notifies set-top 617 to begin sending services to set-top 672 along with the encryption key under which to encrypt all the content. Processing then continues to step 770. Unlike process 400 shown in FIG. 4, process 700 will have set-top 617 distribute content to set-top 672 directly with no head-end involvement and no bandwidth constraints between itself and set-top 672. These instructions and data will unicast since the communication is set-top to set-top.

At step 770 authorization mediation server 280 instructs conditional access server 260 to establish a secure link with set-top box 672 as was done in step 465. However, if content is being forwarded from the user's home set-top 617, the settop encryption key defined in step 775 is also incorporated into the authorization messages to set-top 672 to decrypt the content coming from the set-top 617 as well. The conditional access server 260 then authorizes the hotel set-top 672 with all appropriate encryption keys.

At step 790, the set-top box 672, in conjunction with a television, monitor or stereo, renders the content. Steps 795, 797 and 799 check for a time-out condition as was described in steps 475, 480 and 485 above, returning to step 790 if the timeout has not yet occurred. Additionally, if content is being forwarded from set-top 617 to set-top 672, i.e. the list of missing content is not blank, at step 797 the conditional access server 260 removes the set-top encryption key for the new temporary services sent from set-top 617, set-top 617 ceases passing content to set-top 672, and conditional access server 255 frees the set-top encryption key for future use as well.

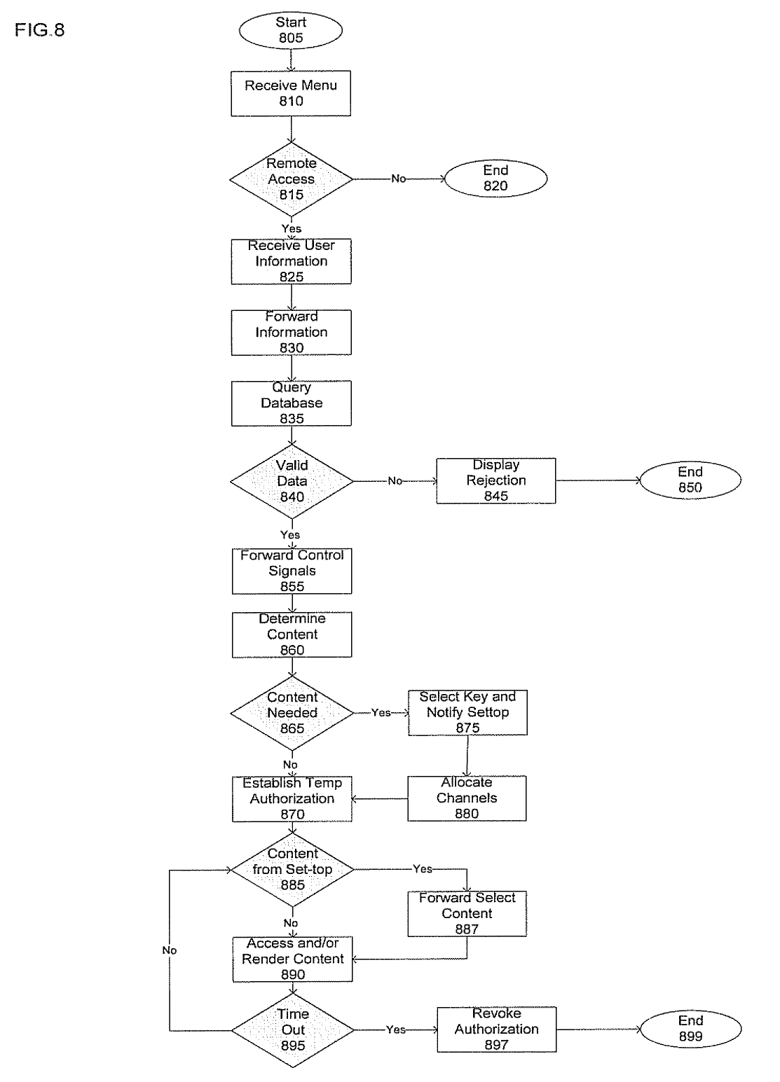

FIG. 8 shows a flowchart for a process for transmitting content from one region to another via the set-top. In this implementation, distinguishing it from FIG. 7 above, the source or home set-top is bandwidth constrained and is thus not able to deliver all missing content to the requesting or visiting set-top. In this implementation the home set-top delivers content to the visiting set-top one content service at a time. Steps 805-880 are the same as steps 705-780 in FIG. 7. The reader is referred to the description of FIG. 7 above.

At step 885, the set-top 672 must determine the source of the content, as defined in the channel line-up. If the source is not set-top 617, then the process continues to step 890. If the source is set-top 617, then processing continues to step 887.

At step 887, set-top 672 notifies set-top 617 via a secure link over connection 637 of the specific content it has been requested to render. Set-top 617 responds by transmitting the requested content directly to set-top 672 using the encryption key defined in step 875. Set-top 617 will continue to deliver the content to set-top 672 until either set-top 672 instructs set-top 617 to begin transmitting a different content service or until processing continues to step 897. If set-top 672 begins to render content not coming from set-top 617, it will ignore the content coming form set-top 617.

At step 890, the set-top 672, in conjunction with a television, monitor or stereo, renders the content. Steps 895, 897 and 899 check for a time-out condition as was described in steps 795, 797 and 799 above, returning to step 885 if the timeout has not yet occurred. Additionally, if content is being forwarded from set-top 617 to set-top 672, i.e. the list of missing content is not blank, at step 897 the conditional access server 260 removes the set-top encryption key for the new temporary services sent from set-top 617, set-top 617 ceases passing content to set-top 672, and conditional access server 255 frees the set-top encryption key for future use as well.

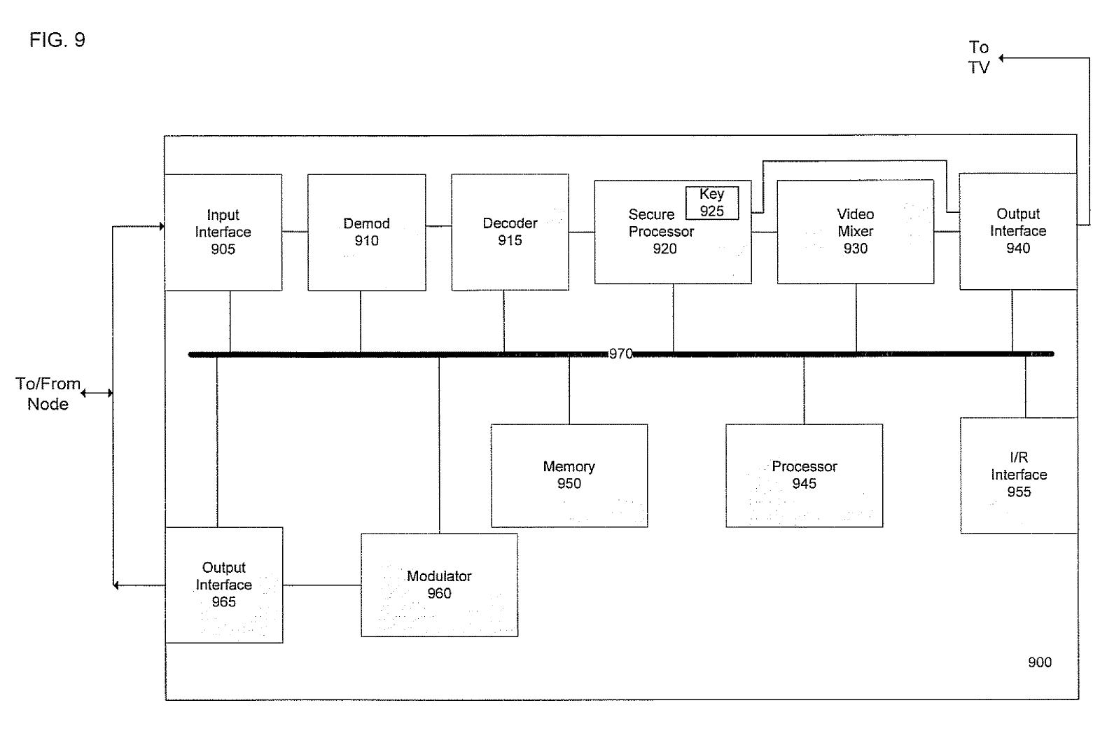

FIG. 9 is a block diagram of a set-top box 900. Set-top box 900 includes an input interface 905 that is coupled to a node via the HFC network. The input interface includes things such as input buffers, amplifiers and filters. In some implementations, input interface 905 includes a tuner for filtering out one particular frequency from a band of frequencies. The content carried on the selected frequency is output from input interface 905 into demodulator 910. Demodulator 910 demodulates the signal. In one implementation, demodulator 910 is a QAM demodulator.

The output of demodulator 910 is input into decoder 915 where the content is decoded. In one implementation, decoder 915 is an MPEG-2 or MPEG-4 decoder. The decoded content is then input into a secure processor 920 where it is decrypted using an encryption key represented by key 925. The content is then split along two paths.

Audio signals are output directly from the secure processor 920 to an output interface 940. The output interface 940 buffers, filters and amplifies the audio signals for output to a television or computer monitor (not shown).

Video signals are output to video mixer 930 where graphical overlays may be added over the video content. The video content is then forwarded to output interface 940 where it is buffered, filtered and amplifies before being transmitted to the television or computer monitor.

Processor 945 controls these various elements. As an example, processor 945 instructs input interface 905 which frequency to tune to or which overlays to add via video mixer 930.

Memory 950 holds instructions and data for processor 945. Thus, instructions for processor 945 to generate a graphical user interface to receive data input by user are stored there. The user inputs his responses using a remote control. The infrared signals are received by I/R interface 955 and forwarded to processor 945.

When set-top box 900 sends data to a head-end, the data is sent from processor 945 to modulator 960 where it is modulated. In one implementation, modulator 950 modulates the data into QAM signals. These signals could include data such as 1) the region or major city nearest the user's home, 2) a user ID or telephone number, 3) a PIN and 4) the length of time to receive the content or a departure date and time.

After the data is modulated, it is forwarded to output interface 965 where it is buffered, filtered and amplified before it is transmitted to a node and eventually the head-end via the HFC.

The processes shown in FIGS. 4, 5, 7 and 8 may be implemented in a general, multi-purpose or single purpose processor. Such a processor will execute instructions, either at the assembly, compiled or machine-level, to perform that process. Those instructions can be written by one of ordinary skill in the art following the description of FIGS. 4, 5, 7 and 8 and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

1. A computer readable medium that contains a computer program comprising instructions wherein those instructions control a processor in a media content processing device in a first region to perform a method comprising:
receiving a request to receive media content not normally available to the media content processing device;
receiving first information identifying a user not associated with the media content processing device;
transmitting the identifying information to a first head-end in the first region coupled to the media content processing device.

2. The computer readable medium of claim 1 further comprising instructions to control the processor to perform the method comprising:
receiving information associated with a time of usage.

3. The computer readable medium of claim 1 further comprising instructions to control the processor to perform the method comprising:
receiving second information identifying a second head-end associated with the user in a second region.

4. The computer readable medium of claim 1 further comprising instructions to control the processor to perform the method comprising:
receiving at least one encryption key;
decrypting the media content not normally available to the media content processing device.

5. A computer readable medium that contains a computer program comprising instructions wherein those instructions control a processor to perform a method comprising:
receiving identification data in a first region;
determining if the identification data identifies an account associated with the first region;
transmitting media content distribution control signals to a second region if the identification data identifies an account associated with the first region; and
wherein the first region is associated with a first head-end and the second region is associated with a second head-end.

6. The computer readable medium of claim 5 further comprising instructions for:
transmitting media content from the first head-end in the first region to the second head-end in the second region if the identification data identifies an account associated with the first region and a portion of the media content is not available in the second region.

7. The computer readable medium of claim 5 further comprising instructions for:
transmitting control signals to a first set-top box in the first region associated with the identified account instructing the first set-top box to transmit at least some media content to a second set-top box in the second region; and
encrypting the at least some content with a specific key.

8. The computer readable medium of claim 7 wherein the control signals include instructions for the set-top box to transmit only a single media content service at a time to a second set-top box in the second region.

9. The computer readable medium of claim 6 further comprising instructions for informing the first head-end to cease distributing media content to the second head-end.

10. The computer readable medium of claim 7 wherein the control signals include instructions for the first set-top box to cease distributing media content to the second set-top box.

11. A computer readable medium that contains a computer program comprising instructions wherein those instructions control a processor to perform a method comprising:
transmitting identification data to a first region;
receiving controls signals from the first region;
selecting media content based on the control signals;
wherein the control signals authorize a set-top in a second region to process the selected media content; and
wherein the first region is associated with a first head-end and the second region is associated with a second head-end and the second set-top resides.

12. The computer readable medium of claim 11 further comprising instructions for:
determining which portion of media content the first head-end does not distribute that is distributed by the second head-end based on the received control signals; and
receiving a second set of media content from the first head-end.

13. The computer readable medium of claim 12further comprising instructions for:
determining and defining one or more channels for carrying the received media content; and
wherein the control signals configure the set-top to process the content on the one or more defined channels.

14. The computer readable medium of claim 12 further comprising instructions for:
allocating bandwidth in the second head-end on which to carry the media content being received from the first head-end.

15. The computer readable medium of claim 11 wherein the selected media content is one media content service.

16. The computer readable medium of claim 11 further comprising instructions for:
determining if a time period has expired and transmitting additional control signals to the set-top to stop processing the selected media content.

17. The computer readable medium of claim 16 wherein the additional control signals comprise:
removing at least one encryption key from the set-top.

18. The computer readable medium of claim 12 further comprising instructions for:
recovering bandwidth used to transmit the second set of media content.

19. The computer readable medium of claim 12 further comprising instructions for:
recovering channels allocated to transmit the second set of media content
